(19) United States
(12) Patent Application Publication
(10) Pub. No.: US 2010/0326855 A1
(43) Pub. Date: Dec. 30, 2010

(54) FASTENER, FASTENER ASSEMBLY AND A METHOD FOR FEEDING SAID FASTENERS TO A FASTENER DRIVING TOOL

(75) Inventor: Kristian Ostergren, Alingsas (SE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW SVERIGE AB, Moelndal (SE)

(21) Appl. No.: 12/668,247

(22) PCT Filed: Jul. 7, 2008
(86) PCT No.: PCT/SE08/50846

§ 371 Date: Jan. 8, 2010

(30) Foreign Application Priority Data
Jul. 9, 2007 (SE) 0701652.0

(51) Int. Cl. F16B 21/08; B25C 5/16

(52) U.S. Cl. 206/343; 227/136

(57) ABSTRACT

The invention relates to a method for feeding fasteners to a fastener driving tool, comprising the steps of determining the number (x) of fasteners required for an operation, assembling a fastener assembly comprising at least two fasteners, wherein the number of fasteners in said fastener assembly is a multiple of the number (x) of fasteners required for the operation and feeding said fastener assembly to said fastener driving tool. The invention also relates to a fastener assembly comprising at least two fasteners, wherein the number of fasteners is a multiple of the number (x). Finally, the invention relates to a fastener comprising attachment means for snap fitting said fastener to another fastener.

### TECHNICAL FIELD

The present invention relates to a method for feeding fasteners to a fastener driving tool. The present invention also relates to a fastener assembly to be used in such a method and a fastener adapted to form such a fastener assembly.

### BACKGROUND ART

It is known to use fasteners, such as nails, screws and clips, in various applications, for example in the automobile industry. The fasteners are usually mounted by means of a manually operated fastener driving tool, for example a nail gun, and are either individually fed to said fastener driving tool or as fastener assemblies, comprising several fasteners held together by a carrier.

Inserting the fasteners individually is a time consuming procedure, which is far from optimal from a cost-efficiency point of view, since every delay in the assembly line is costly to the manufacturer. It is also difficult for the operator to keep track of how many fasteners are left in the fastener driving tool and how many he should insert. Consequently, there is always a risk that the operator will run out of fasteners in the middle of an assembly operation and thus further slow down the assembly process.

EP 0 908 635 discloses a fastener assembly, wherein fasteners are held together by a carrier. Although this arrangement reduces the time required to insert the fasteners into the fastener driving tool, the risk that the operator may run out of fasteners in the middle of a mounting procedure still remains. Accordingly, there is a need for a method for feeding fasteners to a fastener driving tool which overcomes the above problems.

### OBJECT OF THE INVENTION

A first object of the invention is to provide a method for feeding fasteners to a fastener driving tool, which method overcomes the above problems. A second object of the invention is to provide a fastener adapted to this method.

### SUMMARY OF THE INVENTION

Herein, the term fastener includes all kinds of fasteners, such as clips, pins, screws, rivets, nails, bolts etc.

The first object is achieved with a method for feeding fasteners to a fastener driving tool, comprising the steps of determining the number of fasteners required for a specific operation, creating a fastener assembly comprising at least two fasteners, wherein the number of fasteners in said fastener assembly is a multiple of the number of fasteners required for the specific operation, and feeding said fastener assembly to said fastener driving tool.

Advantageously, the number of fasteners in said fastener assembly is equal to the number of fasteners required for the specific operation.

By determining the number of fasteners required for the specific operation in advance and assembling fastener assemblies containing this exact number of fasteners, or a multiple thereof, the risk of having to reload the fastener driving tool during the operation is eliminated. The benefits are reduced production times and, as a consequence thereof, lower manufacturing costs. The fasteners are advantageously attached to each other by means of a snap-fit connection, which makes them easy to assemble and separate. Herein, a snap-fit connection is a connection formed by mating fastening members, of which at least one is flexible and arranged to snap past the other (or a part thereof) so as to lock said members together.

The invention also relates to a fastener assembly to be used in the above method, which fastener assembly comprises at least two fasteners, wherein the number of fasteners in said fastener assembly is a multiple of the number of fasteners required for a specific operation.

Advantageously, the number of fasteners in said fastener assembly is equal to the number of fasteners required for said specific operation.

The benefits of such fastener assemblies are easy handling (in comparison to individually inserted fasteners), reduced production times and lower manufacturing costs. One advantage of assembling exactly as many fasteners as needed for performing the operation once is that the operator of the fastener driving tool knows that a new fastener assembly has to be inserted after every operation. Accordingly, the operator will be less likely to forget to refill the fastener driving tool, a mistake that if not discovered until the next time the fastener driving tool is to be used may result in prolonged assembly times. On the other hand, a fastener assembly containing twice that as many fasteners or more will last longer and further reduce the assembly times.

The fasteners are preferably attached to each other by means of a snap-fit connection, since this allows for quick and easy assembly and disassembly, and thus lower manufacturing costs.

The second object is achieved with a fastener adapted to be a part of a fastener assembly of the above described kind, which fastener comprises attachment means for snap fitting said fastener to another fastener.

Since the fasteners are attached directly to each other, there is no need for a carrier connecting said fasteners. The benefits are lower material costs and a quicker and simpler assembly process, which in reduces the manufacturing costs. Furthermore, a snap connection makes it easy to detach the fasteners if necessary.

An alternative way of attaching two fasteners to each other is to use some sort of locking mechanism, for example a hook and eye arrangement,

The fasteners are advantageously releasably connected, as this makes it easier to detach them from each other, for example in case on fastener is defect.

### BRIEF DESCRIPTION OF THE DRAWINGS

The invention will now be explained in further detail with reference to the accompanying drawings, wherein:

FIG. 1 shows a flow chart over an automobile assembly line.

FIG. 2 shows a perspective view of a fastener according to the invention;

FIG. 3 shows a fastener assembly according to the invention; and

FIG. 4 shows another kind of fastener according to the invention.

### DETAILED DESCRIPTION OF THE INVENTION

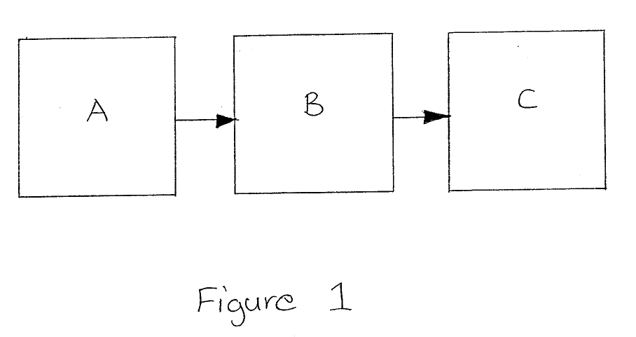

The fasteners referred to in this application may be of any known kind, including clips, nails, screws, rivets etc. It is also understood that the clips referred to in the following description may be replaced by any kind of fastener and that the clip gun may be replaced by any kind of fastener driving tool, without departing from the scope of the invention. Furthermore, although the embodiment in FIG. 1 relates to an automobile application, the described methods, fasteners and fastener assemblies are applicable to all kinds of operations involving a fastener.

Throughout the application, the term “connected to” implies that two fasteners are either directly connected to each other or connected by means of an intermediate piece, while the term “attached to” implies that the fasteners are directly connected to each other.

FIG. 1 shows schematically an automobile assembly line wherein step A represents all operations carried out prior to step B, step B the installation of a specific piece of equipment and step C all subsequent operations. The piece is attached by means of fasteners, x in number, which are mounted by means of a manually operated fastener driving tool.

The fasteners are arranged in fastener assemblies by means of a fastener assembling device before insertion into the fastener driving tool and each fastener assembly contains x fasteners, or a multiple thereof. The operator inserts one or more fastener assemblies into the fastener driving tool, preferably before the piece of equipment to be installed has arrived at his/her station, and then attaches said piece of equipment using the fastener driving tool. Since each fastener assembly contains exactly x fasteners or a multiple thereof, the operator will not run out of fasteners during the operation and loose time while inserting new ones. After the installation, the operator inserts one or more fastener assemblies into the fastener driving tool if necessary (advantageously, the fastener driving tool is provided with an indicator indicating that a refill is required) before continuing with the next piece.

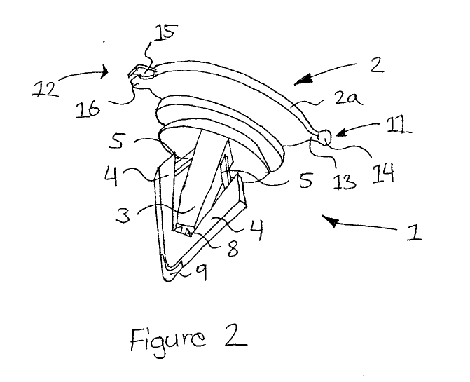

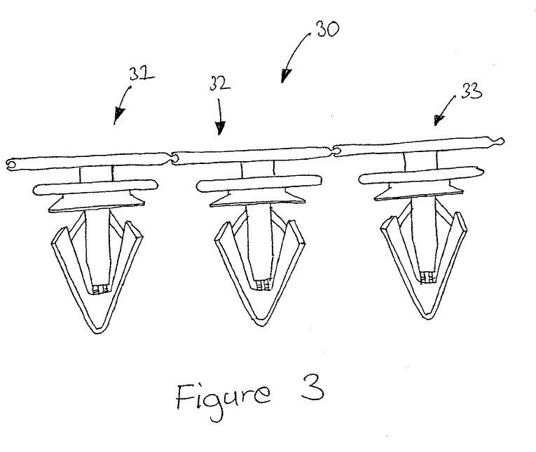

With reference to FIGS. 2 and 3, we will now describe a fastener in the form of a clip, adapted to be attached to other clips so as to form a clip assembly. FIG. 2 shows a perspective view of the clip 1 (this clip is disclosed without attachment means in the European patent EP 1 712 801 A1). The clip 1 may be made of plastic or any other suitable material and comprises a head 2 with an outermost portion 2a, a body 3 that extends perpendicular to the head 2 and a plurality of resilient legs 4 joined to the body 3 by a plurality of tethers 5. When the clip 1 is inserted into a hole in a panel (not shown) the legs 4 are forced inwards by the edge of said panel. After passing through the hole, the legs 4 flex outward again, creating an interference between the backside of the panel and the legs 4 so as to secure the clip in the hole. However, if a sufficient force is applied, retaining tabs 8 located at the end of the body will release from a hole 9 defined by the common end of the legs, in which hole 9 they are snap-fitted, and the body 3 will move upwards. Thereafter, the tethers 5 will force the legs 4 towards the body 3, so that the clip 1 may be pulled out without damaging the panel.

The outermost portion 2a of the head is provided with first and second attachment means 11, 12 for attaching said clip 1 to another clip (see FIG. 3). Said first attachment means 11 comprises an extension arm 13 that extends in the plane of and outwards from the outermost head portion 2a. At the distal end thereof, the extension arm 13 is provided with a spherical retaining member 14. Said second attachment means 12 is located on the opposite side of the head 2 relative said first attachment 11 means and consists of two opposing, curved gripping arms 15, 16 that define a receiving space, for receiving the retaining member of another clip in a snap-fit.

FIG. 3 shows a clip assembly 30, comprising three clips 31, 32, 33 of the above described type, ready to be inserted into a clip gun (not shown). Once the assembly 30 is inserted into the clip gun, the innermost clip 31 is detached from the others and fed to the muzzle, to be expelled out the front of the clip gun when the clip gun is fired (alternatively, the clip 31 is not detached from the others until it is inside the muzzle or expelled). This process continues until there are no clips left in the gun. The attachment means on said clip may break away when the clip is expelled, or be removed before that, so that the clip forced into the panel may present an aesthetically pleasing clip head.

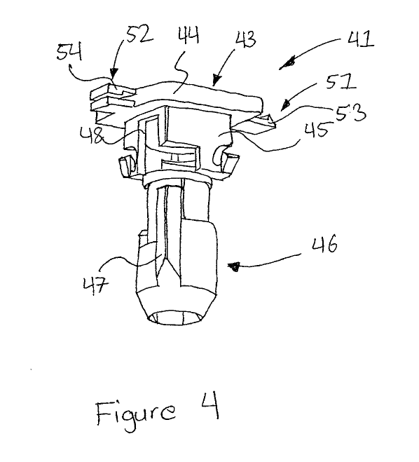

FIG. 4 shows another fastener 41 for connecting a first component having a first hole to a second component having a second hole. Such a fastener is described in detail in WO 2007/007180 A1. Said fastener includes a cage 43 which is fitted at its end with a radial flange 44 and further a cross-sectionally rectangular or square shank segment 45. This shank segment 45 is insertable into the second hole of the second component, for resting against the associated side of the second component. A nut 46 is at least partly axially received in the cage 43 and is rotatable from a first rotational position in the cage into a second rotational position. The nut 46 has an axial borehole to receive an affixation screw (not shown) and also comprises at its outside diametrically opposite wing elements 47. When the affixation screw is screwed into the nut 46, said nut is rotated from the first into the second rotational position and the wing elements 47 will be pulled on account of the affixation screw's rotation in the nut until they come to a stop against associated sidewalls of clearances 48. When the affixation screw is tightened further, the nut 46 will move axially into the cage 43 until a surface of the wing elements 47 engages a facing surface of the component. In this position, a locking segment prevents the nut 46 from rotating back. Said fastener 41 is provided with first and second attachment means 51, 52 for attaching said fastener 41 to other fasteners so as to form a fastener assembly to be inserted into a fastener driving tool. Said first attachments means 51 consists of a hook member 53 extending in the plane of the flange 44 and said second attachment means 52, located on the opposite side of the flange 44, consists of two gripping arms 54, adapted to receive said hook member 53 in a snap fit connection.

The skilled person realizes that the invention may be amended in various ways, without parting from the scope of the invention. There are for example various ways to form fastener assemblies, such as arranging the fasteners in magazines or connecting them by means of one or more carriers, which may be a strip with an adhesive applied thereon or of a more rigid construction, such as the one disclosed in EP 0 908 635. In the latter case, the carrier advantageously breaks away when the fastener is expelled from the fastener driving tool. In case the fasteners are attached directly to each other, the connection may also be formed by heat sealing, adhesive attachment or by some sort of locking mechanism. The fasteners may also be heat sealed, attached by means of an adhesive or connected by some sort of locking mechanism. Of course, the fastener assembling tool and fastener driving device have to be adapted to the way the fasteners are assembled.

Furthermore, the skilled person realizes that the snap fit between the fasteners described with reference to FIGS. 2-4 may be achieved with all kinds of snap connections and that the disclosed snap connections are merely intended as an example. Such snap connections may resemble the ones shown in FIGS. 2-4 or have a totally different design. It is for example possible to form a recess in the head of one fastener, in which a gripping member of another fastener is snap-fitted. It is also possible to shorten one or both gripping arms, to allow the clips some rotational freedom in order to make the fastener assembly easier to handle and the fasteners easier to detach. Said attachment means may also be located elsewhere on the fastener. It is of course also possible to provide a fastener with several attachment means and connect each fastener to three or more fasteners, although the fasteners preferably are arranged in a row.

Finally, the fasteners may be manually assembled into fastener assemblies and they may also be manually detached from each other.

1. Method for feeding fasteners to a fastener driving tool, comprising the steps of:
determining the number (x) of fasteners required for a specific operation;
assembling a fastener assembly comprising at least two fasteners, wherein the number of fasteners in said fastener assembly is a multiple of the number (x) of fasteners required for the specific operation; and
feeding said fastener assembly to said fastener driving tool.

2. Method according to claim 1, characterised in that the number of fasteners in said fastener assembly is equal to the number (x) of fasteners required for the specific operation.

3. Method according to claim 1, characterised in that said fasteners in said fastener assembly are attached to each other by means of a snap-fit connection.

4. Fastener assembly to be used in a method according to claim 1, which fastener assembly comprises at least two fasteners, characterised in that the number of fasteners in said fastener assembly is a multiple of the number (x) of fasteners required for a specific operation.

5. Fastener assembly according to claim 4, characterised in that the number of fasteners in said fastener assembly is equal to the number (x) of fasteners required for said specific operation.

6. Fastener assembly according to claim 4, characterised in that said fasteners are attached to each other by means of a snap-fit connection.

7. Fastener adapted to be a part of a fastener assembly according to claim 4, characterised in that said fastener comprises attachment means for snap fitting said fastener to another fastener.
